(19) United States
(12) Patent Application Publication
(10) Pub. No.: US 2007/0265364 A1
(43) Pub. Date: Nov. 15, 2007

(54) Adhesion-modified expandable polyolefin compositions and insulated vehicle parts containing expanded adhesion-modified polyolefin compositions

(76) Inventors: Didem Oner-Deliomanli, Lake Orion, MI (US); Huzeir Lekovic, Troy, MI (US); Kalyan Sehanobish, Rochester, MI (US); Michael T. Malanga, Clarkston, MI (US); Sikanth Miryala, Farmington Hills, MI (US)

Correspondence Address: GARY C. COHN, PLLC, 1147 NORTH FOURTH STREET, UNIT 6E, PHILADELPHIA, PA, 19123, US

(21) Appl. No.: 11/784,352

(22) Filed: Apr. 6, 2007

Related U.S. Application Data
(60) Provisional application No. 60/790,328, filed on Apr. 6, 2006.

(51) Int. Cl. C08J 9/00

(52) U.S. Cl. 521/134

(57) ABSTRACT

Polyolefin compositions that expand freely to form stable foams are disclosed. The compositions contain specified levels of adhesion-promoting resins. The compositions include at least one heat-activated expanding agent and typically include at least one heat-expanded crosslinker. The compositions are effective as sealers and noise/vibration insulation in automotive applications.

### CROSS-REFERENCE TO RELATED APPLICATION

This application claims benefit of U.S. Provisional Application No. 60/790,328, filed Apr. 6, 2006.

### BACKGROUND OF THE INVENTION

The present invention relates to expandable polyolefin compositions and uses thereof as foam-in-place reinforcement and/or insulation materials.

Polymeric foams are finding increasing application in the automotive industry.

These foams are used for structural reinforcement, preventing corrosion and damping sound and vibration. In many cases, manufacturing is simplest and least expensive if the foam can be formed in the place where it is needed, rather than assembling a previously-foamed part to the rest of the structure.

Foam-in-place formulations have gained favor because in many cases the foaming step can be integrated into other manufacturing processes. In many cases, the foaming step can be conducted at the same time as automotive coatings (such as cationic deposition primers such as the so-called “E-coat” materials) are baked and cured. These foams can be formed in such cases by applying a reactive foam formulation to an automotive part or subassembly, before or after applying the E-coat, and then baking the coating. The foam formulation then expands and cures as the coating is baked.

Polyurethane foams are used in these applications, as they usually exhibit excellent adhesion to the substrate. However, polyurethane foams suffer from two significant problems. The first problem is that these foam formulations are usually two-part compositions. This means that starting materials must be metered, mixed and dispensed, which often requires equipment which not only can be expensive but also can take up a large amount of factory space. There are some one-part moisture curable polyurethane foam compositions that can be used in these applications, but moisture curing is slow and usually cannot result in low density foams.

The second problem with polyurethane foam is that of worker exposure to reactive chemicals like amines and isocyanates.

In addition to these problems, foamable polyurethane compositions often must be applied after coatings such as E-coats are baked and cured.

As a result of these problems, there have been attempts to substitute the polyurethane foams with expandable polyolefin compositions. The polyolefins have the advantage of being solid, one-component materials. As such, they can be extruded or otherwise formed into convenient shapes and sizes for insertion into specific cavities that require foam reinforcement or insulation. These compositions can be formulated so they expand under conditions of the E-coat baking step.

Heat resistance and adhesion to the substrate are concerns with the expandable polyolefin compositions, and for those reasons copolymers of ethylene with a polar, oxygen-containing monomer have been favored in these applications. Thus, for example, in U.S. Pat. No. 5,385,951, an ethylene-methyl methacrylate copolymer is described as a polyolefin of choice due to its foaming characteristics, thermal stability and adhesive properties. In EP 452 527A1 and EP 457 928 A1, a copolymer of ethylene and a polar comonomer such as vinyl acetate is preferred due to the heat resistance of these copolymers. WO 01/30906 describes using a maleic anhydride-modified ethylene-vinyl acetate copolymer.

Expandable polyolefins have not performed optimally in these applications. Stable foam formation requires that the polyolefin becomes crosslinked during the expansion process. The timing of the crosslinking reaction in relation to the softening of the polyolefin and the activation of the expanding agent is very important. If the crosslinking occurs too early, the resinous mass cannot expand fully. Late crosslinking also can result in incomplete expansion or even foam collapse. As a result of these problems, commercially available expandable polyolefin products usually expand to only 300 to 1600% of their initial volume. Higher expansion is desired, in order to more completely fill cavities using minimal amounts of material. A material that expands to 1800% or more, especially 2000% or more of its initial volume is highly desirable.

A further complication with compositions as described in U.S. Pat. No. 5,385,951, EP 452 527A1, EP 457 928A1 and WO 01/30906 is that the polyolefin tends to soften too early during the expansion process. The softened or melted resin tends to flow to the bottom of the cavity before it can crosslink and expand. If the cavity is not capable of retaining fluids, the polyolefin composition can even leak out before expansion and crosslinking can occur.

As a result, the expanded material tends to occupy the bottom of the cavity rather than uniformly filling the available space. If the cavity is small, this problem can be solved by simply using more of the expandable composition. This increases costs and does not solve the problem when larger or more complex cavities are to be filled. In some instances, the reinforcement or insulation is needed in only a portion of the cavity. It is very difficult to use an expandable polyolefin in those cases, unless that portion happens to be the bottom of the cavity, because of the tendency for the expandable polyolefins to run when heated.

As a result of these problems, it is common to form the expandable polyolefin composition onto a higher-melting support. The support helps to hold the polyolefin composition in position within the cavity until the expansion step is completed. Such supports tend only to retard, not prevent, the expandable polyolefin composition from running, unless the support is designed (and properly oriented) to retain fluids. Another problem with this approach is that it adds manufacturing steps and therefore increases costs. Furthermore, the supported expandable polyolefin often must be designed individually for each cavity in which it will be used. This adds even more to the cost, as specialized parts must be produced and inventoried. Despite this extra cost and complexity, very high failure rates are experienced with the expandable polyolefins. It would be highly desirable to produce an expandable polyolefin composition that could be produced inexpensively, preferably in a simple extrusion process, in a form that can be used easily to fill a variety of cavities, and which has low failure rates.

### SUMMARY OF THE INVENTION

In one aspect, this invention is a solid, thermally expandable polyolefin composition, comprising:

a) from 35 to 65%, based on the weight of the composition, of (1) a crosslinkable ethylene homopolymer, (2) a crosslinkable interpolymer of ethylene and at least one C₃₋₂₀ α-olefin or non-conjugated diene or triene comonomer, (3) a crosslinkable ethylene homopolymer or interpolymer of ethylene and at least one C₃₋₂₀ α-olefin containing hydrolyzable silane groups or (4) a mixture of two or more of the foregoing, the homopolymer, interpolymer or mixture being non-elastomeric and having a melt index of from 0.5 to 30 g/10 minutes when measured according to ASTM D 1238 under conditions of 190° C./2.16 kg load;

b) from 0.5 to 8% by weight, based on the weight of the composition, of a heat activated crosslinker for component a), said crosslinker being activated when heated to a temperature of at least 120° C. but not more than 300° C.;

c) from 2 to 20%, based on the weight of the composition, of a heat-activated expanding agent that is activated when heated to a temperature of at least 120° C. but not more that 300° C.; and

d) from 2.5 to 30%, based on the weight of the composition, of an adhesion-promoting resin.

In a preferred embodiment, this invention is a solid, thermally expandable polyolefin composition, comprising:

a) from 35 to 65%, based on the weight of the composition, of (1) a crosslinkable ethylene homopolymer, (2) a crosslinkable interpolymer of ethylene and at least one C₃₋₂₀ α-olefin or non-conjugated diene or triene comonomer, (3) a crosslinkable ethylene homopolymer or interpolymer of ethylene and at least one C₃₋₂₀ α-olefin containing hydrolyzable silane groups or (4) a mixture of two or more of the foregoing, the homopolymer, interpolymer or mixture being non-elastomeric and having a melt index of from 0.5 to 30 g/10 minutes when measured according to ASTM D 1238 under conditions of 190° C./2.16 kg load;

b) from 0.5 to 8% by weight, based on the weight of the composition, of a peroxide crosslinker for component a), said crosslinker being activated when heated to a temperature of at least 120° C. but not more than 300° C.;

c) from 10 to 20%, based on the weight of the composition, of an azo-type expanding agent that is activated when heated to a temperature of at least 120° C. but not more that 300° C.; and

d) from 5 to 30%, based on the weight of the composition, of an adhesion-promoting resin.

In another preferred embodiment, this invention is a solid, thermally expandable polyolefin composition, comprising:

a) from 35 to 65%, based on the weight of the composition, of (1) a crosslinkable ethylene homopolymer, (2) a crosslinkable interpolymer of ethylene and at least one C₃₋₂₀ α-olefin or non-conjugated diene or triene comonomer, (3) a crosslinkable ethylene homopolymer or interpolymer of ethylene and at least one C₃₋₂₀ α-olefin containing hydrolyzable silane groups or (4) a mixture of two or more of the foregoing, the homopolymer, interpolymer or mixture being non-elastomeric and having a melt index of from 0.5 to 30 g/10 minutes when measured according to ASTM D 1238 under conditions of 190° C./2.16 kg load;

b) from 0.5 to 8% by weight, based on the weight of the composition, of a peroxide crosslinker for component a), said crosslinker being activated when heated to a temperature of at least 120° C. but not more than 300° C.;

c) from 10 to 20%, based on the weight of the composition, of an azo-type expanding agent that is activated when heated to a temperature of at least 120° C. but not more that 300° C.;

d) from 4 to 20%, based on the weight of the composition, of an accelerator for the azo-type expanding agent; and

e) from 5 to 30%, based on the weight of the composition, of an adhesion-promoting resin.

This invention is also a method comprising

1) inserting the solid, thermally expandable polyolefin composition of the invention into a cavity,

2) heating the thermally expandable polyolefin composition in the cavity to a temperature sufficient to expand and crosslink the polyolefin composition and

3) permitting the polyolefin composition to expand freely to form a foam that fills at least a portion of the cavity.

The thermally expandable composition of the invention offers several advantages. It is typically capable of achieving high degrees of expansion under use conditions. Expansions of greater than 1000%, greater than 1500%, greater than 1800% and even greater than 2500% of the initial volume of the composition are often seen across a range of baking temperatures from 150 to over 200° C. In many cases, the thermally expandable composition is self-supporting during the expansion process. This can eliminate the need to attach the composition to a support to keep the composition from flowing to the bottom of the cavity during the expansion process. The expanded composition exhibits good adhesion to coated substrates (particularly those coated with a cured cationic primer), and often exhibits good adhesion to oily cold rolled steel or oily galvanized steel substrates. In addition, the expanded composition tends to be highly dimensionally stable when exposed repeatedly to high temperatures, as are often encountered in automotive assembly operations.

### DETAILED DESCRIPTION OF THE INVENTION

The composition of the invention contains as a main ingredient an ethylene homopolymer or certain ethylene interpolymers. The homopolymer or interpolymer is non-elastomeric, meaning for purposes of this invention that the homopolymer or interpolymer exhibits an elastic recovery of less than 40 percent when stretched to twice its original length at 20° C. according to the procedures of ASTM 4649.

The ethylene polymer (component a)) has a melt index (ASTM D 1238 under conditions of 190° C./2.16 kg load) of 0.5 to 30 g/10 minutes. The melt index is preferably from 0.5 to 25 g/10 minutes, as higher melt index polymers tend to flow more, have lower melt strength and may not crosslink rapidly enough during the heat expansion step. A more preferred ethylene polymer has a melt index of 1 to 15 g/10 minutes, and an especially preferred polymer has a melt index of 1 to 5 g/10 minutes.

The ethylene polymer (component a)) preferably exhibits a melting temperature of at least 105° C., and more preferably at least 110° C.

A suitable type of interpolymer is one of ethylene and at least one C₃₋₂₀ α-olefin. Another suitable type of interpolymer is one of ethylene and at least one non-conjugated diene or triene monomer. The interpolymer may be one of ethylene, at least one C₃₋₂₀ α-olefin and at least one non-conjugated diene monomer. The interpolymer is preferably a random interpolymer, where the comonomer is distributed randomly within the interpolymer chains. Any of the foregoing homopolymers and copolymers may be modified to contain hydrolyzable silane groups. The homopolymers and interpolymers suitably contain less than 2 mole percent of repeating units formed by polymerizing an oxygen-containing monomer (other than a silane-containing monomer). The homopolymers and interpolymers suitably contain less than 1 mole percent of such repeating units and more preferably less than 0.25 mole percent of such repeating units. They are most preferably devoid of such repeating units.

Examples of such polymers include low density polyethylene (LDPE), high density polyethylene (HDPE) and linear low density polyethylene (LLDPE). Also useful are so-called “homogeneous” ethylene/α-olefin interpolymers that contain short-chain branching but essentially no long-chain branching (i.e., less than 0.01 long chain branch/1000 carbon atoms). In addition, substantially linear ethylene α-olefin interpolymers that contain both long-chain and short-chain branching are useful, as are substantially linear, long-chain branched ethylene homopolymers. “Long-chain branching” refers to branches that have a chain length longer than the short chain branches that result from the incorporation of the α-olefin or non-conjugated diene monomer into the interpolymer. Long chain branches are preferably greater than 10, more preferably greater than 20, carbon atoms in length. Long chain branches have, on average, the same comomoner distribution as the main polymer chain and can be as long as the main polymer chain to which it is attached. Short-chain branches refer to branches that result from the incorporation of the α-olefin or non-conjugated diene monomer into the interpolymer.

LDPE is a long-chain branched ethylene homopolymer that is prepared in a high-pressure polymerization process using a free radical initiator. LDPE preferably has a density of less than or equal to 0.935 g/cc (all resin densities are determined for purposes of this invention according to ASTM D792). It preferably has a density of from 0.905 to 0.930 g/cc and especially from 0.915 to 0.925 g/cc. LDPE is a preferred ethylene polymer due to its excellent processing characteristics and low cost. Suitable LDPE polymers include those described in U.S. Provisional Patent Application 60/624,434 and WO 2005/035566.

HDPE is a linear ethylene homopolymer or ethylene-α-olefin copolymer that consists mainly of long linear polyethylene chains. A comonomer can be used in HDPE resins to impart short chain branches as a means of adjusting the density of the particular HDPE grade HDPE typically contains less than 0.01 long chain branch/1000 carbon atoms. It suitably has a density of at least 0.94 g/cc. HDPE is suitably prepared in a low-pressure polymerization process using Zeigler polymerization catalysts, as described, for example, in U.S. Pat. No. 4,076,698.

LLDPE is a short-chain branched ethylene-α-olefin interpolymer having a density of less than 0.940. It is usually prepared in a low pressure polymerization process using Zeigler catalysts in a manner similar to HDPE, but can be made using metallocene catalysts. The short-chain branches are formed when the α-olefin comonomers become incorporated into the polymer chain. LLDPE typically contains less than 0.01 long chain branch/1000 carbon atoms. The density of the LLDPE is preferably from about 0.905 to about 0.935 and especially from about 0.910 to 0.925. The α-olefin comonomer suitably contains from 3 to 20 carbon atoms, preferably from 3 to 12 carbon atoms. Propylene, 1-butene, 1-pentene, 4-methyl-1-pentene, 1-hexene, 4-methyl-1-hexene, 5-methyl-1-hexene, 1-octene, 1-nonene, 1-decene, 1-undecene, 1-dodecene and vinylcyclohexane are suitable α-olefin comonomers. Those having from 4 to 8 carbon atoms are especially preferred.

“Homogeneous” ethylene/α-olefin interpolymers are conveniently made as described in U.S. Pat. No. 3,645,992, or by using so-called single site catalysts as described in U.S. Pat. Nos. 5,026,798 and 5,055,438. The comonomer is randomly distributed within a given interpolymer molecule, and the interpolymer molecules each tend to have similar ethylene/comonomer ratios. These interpolymers suitably have a density of less than 0.940, preferably from 0.905 to 0.930 and especially from 0.915 to 0.925. Comonomers are as described above with respect to LLDPE.

Substantially linear ethylene homopolymers and copolymers include those made as described in U.S. Pat. Nos. 5,272,236 and 5,278,272. These polymers suitably have a density of less than or equal to 0.97 g/cc, preferably from 0.905 to 0.930 g/cc and especially from 0.915 to 0.925. The substantially linear homopolymers and copolymers suitably have an average of 0.01 to 3 long chain branch/1000 carbon atoms, and preferably from 0.05 to 1 long chain branch/1000 carbon atoms. These substantially linear polymers tend to be easily processible, similar to LDPE, and are also preferred types on this basis. Among these, the ethylene/α-olefin interpolymers are more preferred. Comonomers are as described above with respect to LLDPE.

In addition to the foregoing, interpolymers of ethylene and at least one nonconjugated diene or triene monomer can be used. These interpolymers can also contain repeating units derived from an α-olefin as described before. Suitable nonconjugated diene or triene monomers include, for example, 7-methyl-1,6-octadiene, 3,7-dimethyl-1,6-octadiene, 5,7-dimethyl-1,6-octadiene, 3,7,11-trimethyl-1,6,10-octatriene, 6-methyl-1,5-heptadiene, 1,6-heptadiene, 1,7-octadiene, 1,8-nonadiene, 1,9-decadiene, 1,10-undecadiene, bicyclo[2.2.1]hepta-2,5-diene (norbornadiene), tetracyclododecene, 1,4-hexadiene, 4-methyl-1,4-hexadiene, 5-methyl-1,4-hexadiene and 5-ethylidene-2-norborene.

The ethylene homopolymer or interpolymer, of any of the foregoing types, can contain hydrolyzable silane groups. These groups can be incorporated into the polymer by grafting or copolymerizing with a silane compound having at least one ethylenically unsaturated hydrocarbyl group attached to the silicon atom and at least one hydrolyzable group attached to the silicon atom. Methods of incorporating such groups are described, for example, in U.S. Pat. Nos. 5,266,627 and 6,005,055 and WO 02/12354 and WO 02/12355. Examples of ethylenically unsaturated hydrocarbyl groups include vinyl, allyl, isopropenyl, butenyl, cyclohexenyl and γ-(meth)acryloxy allyl groups. Hydrolyzable groups include methoxy, ethoxy, formyloxy, acetoxy, propionyloxy, and alkyl- or arylamino groups. Vinyltrialkoxysilanes such as vinyltriethyoxysilane and vinyltrimethyoxysilane are preferred silane compounds; the modified ethylene polymers in such cases contain triethoxysilane and trimethoxysilane groups, respectively.

Mixtures of two or more of the foregoing ethylene homopolymers or copolymers can be used. In such a case, the mixture will have a melt index as described above.

Ethylene homopolymers or interpolymers having long-chain branching are generally preferred, as these resins tend to have good melt strength and/or extensional viscosities which help them form stable foams. Mixtures of long-chain branched and short-chain branched or linear ethylene polymers are also useful, as the long-chain branched material in many cases can provide good melt strength and/or high extensional viscosity to the mixture. Thus, mixtures of LDPE with LLDPE or HDPE can be used, as can mixtures of substantially linear ethylene homopolymers and interpolymers with LLDPE or HDPE. Mixtures of LDPE with a substantially linear ethylene homopolymer or interpolymer (especially interpolymer) can also be used.

The ethylene homopolymer or copolymer constitutes from 35 to 65% of the weight of the composition. It preferably constitutes up to 60% and more preferably up to 55% of the weight of the composition. Preferred compositions of the invention contain from 38 to 53% by weight of the ethylene polymer or copolymer, or from 40 to 50% thereof.

The crosslinker is a material that, either by itself or through some degradation or decomposition product, forms bonds between molecules the ethylene homopolymer or interpolymer (component (a)). The crosslinker is heat-activated, meaning that below a temperature of 120° C., the crosslinker reacts very slowly or not at all with the ethylene polymer or interpolymer, such that a composition is formed which is storage stable at approximately room temperature (˜22° C.).

There are several possible mechanisms through which the heat-activation properties of the crosslinker can be achieved. A preferred type of crosslinker is relatively stable at lower temperatures, but decomposes at temperatures within the aforementioned ranges to generate reactive species which form the crosslinks. Examples of such crosslinkers are various organic peroxy compounds as described below. Alternatively, the crosslinker may be a solid and therefore relatively unreactive at lower temperatures, but which melts at a temperature from 120 to 300° C. to form an active crosslinking agent. Similarly, the crosslinker may be encapsulated in a substance that melts, degrades or ruptures within the aforementioned temperature ranges. The crosslinker may be blocked with a labile blocking agent that deblocks within those temperature ranges. The crosslinker may also require the presence of a catalyst or free-radical initiator to complete the crosslinking reaction. In such a case, heat activation may be accomplished by including in the composition a catalyst or free radical initiator that becomes active within the aforementioned temperature ranges.

A crosslinking agent is present in the composition of the invention. The crosslinking agent is suitably used in an amount from 0.5 to 8%, based on the weight of the entire composition, It is generally desirable to use enough of the crosslinking agent (together with suitable processing conditions) to produce an expanded, crosslinked composition having a gel content of at least 10% by weight and especially about 20% by weight. Gel content is measured for purposes of this invention in accordance with ASTM D-2765-84, Method A.

A wide range of crosslinkers can be used with the invention, including peroxides, peroxyesters, peroxycarbonates, poly(sulfonyl azides), phenols, azides, aldehyde-amine reaction products, substituted ureas, substituted guanidines, substituted xanthates, substituted dithiocarbamates, sulfur-containing compounds such as thiazoles, imidazoles, sulfenamides, thiuramidisulfides, paraquinonedioxime, dibenzoparaquinonedioxime, sulfur and the like. Suitable crosslinkers of those types are described in U.S. Pat. No. 5,869,591.

A preferred type of crosslinker is an organic peroxy compound, such as an organic peroxide, organic peroxyester or organic peroxycarbonate. Organic peroxy compounds can be characterized by their nominal 10-minute half-life decomposition temperatures. The nominal 10-minute half-life decomposition temperature is that temperature at which one half of the organic peroxy decomposes in 10 minutes under standard test conditions. Thus, if an organic peroxy compound has a nominal 10-minute half-life temperature of 110° C., 50% of the organic peroxy compound will decompose when exposed to that temperature for 10 minutes. Preferred organic peroxy compounds have nominal 10-minute half-lives in the range of 120 to 300° C., especially from 140 to 210° C., under the standard conditions. It is noted that the actual rate of decomposition of an organic peroxy compound may be somewhat higher or lower than the nominal rate, when it is formulated into the composition of the invention. Examples of suitable organic peroxy compounds include t-butyl peroxyisopropylcarbonate, t-butyl peroxylaurate, 2,5-dimethyl-2,5-di(benzoyloxy)hexane, t-butyl peroxyacetate, di-t-butyl diperoxyphthalate, t-butyl peroxymaleic acid, cyclohexanone peroxide, t-butyl diperoxybenzoate, dicumyl peroxide, 2,5-dimethyl-2,5-di(t-butylperoxy)hexane, t-butylcumyl peroxide, t-butyl hydroperoxide, di-t-butyl peroxide, 1,3-di(t-butylperoxyisopropyl)benzene, 2,5-dimethyl-2,5-di-t-butylperoxy)hexyne-3, di-isopropylbenzene hydroperoxide, p-methane hydroperoxide and 2,5-dimethylhexane-2,5-dihydroperoxide. A preferred expanding agent is dicumyl peroxide. A preferred quantity of organic peroxy crosslinkers is from 0.5 to 5 percent of the weight of the composition.

Suitable poly(sulfonyl azide) crosslinkers are compounds having at least two sulfonyl azide (—SO₂N₃) groups per molecule. Such poly(sulfonyl azide) crosslinkers are described, for example, in WO 02/068530. Examples of suitable poly(sulfonyl azide) crosslinkers include 1,5-pentane bis(sulfonyl azide), 1,8-octane bis(sulfonyl azide), 1,10-decane bis(sulfonyl azide), 1,18-octadecane bis(sulfonyl azide), 1-octyl-2,4,6-benzene tris(sulfonyl azide), 4,4′-diphenyl ether bis(sulfonyl azide), 1,6-bis(4′-sulfonazidophenyl)hexane, 2,7-naphthalene bis(sulfonyl azide), oxy-bis(4-sulfonylazido benzene), 4,4′-bis(sulfonyl azido)biphenyl, bis(4-sulfonylazidophenyl)methane and mixed sulfonyl azides of chlorinated aliphatic hydrocarbons that contain an average of from 1 to 8 chlorine atoms and from 2 to 5 sulfonyl azide groups per molecule.

When the ethylene polymer contains hydrolyzable silane groups, water is a suitable crosslinking agent. The water may diffuse in from a humid environment. Water also may be added to the composition. In this case, water suitably is used in an amount of from about 0.1 to 1.5 percent based on the weight of the composition. Higher levels of water will also serve to expand the polymer. Typically, a catalyst is used in conjunction with water in order to promote the curing reaction. Examples of such catalysts are organic bases, carboxylic acids, and organometallic compounds such as organic titanates and complexes or carboxylates of lead, cobalt, iron, nickel, tin or zinc. Specific examples of such catalysts are dibutyltin dilaurate, dioctyltinmaleate, dibutyltindiacetate, dibutyltindioctoate, stannous acetate, stannous octoate, lead naphthenate, zinc caprylate and cobalt naphthenate. Polysubstituted aromatic sulfonic acids as described in WO 2006/017391 are also useful. In order to prevent premature crosslinking, the water or catalyst, or both, may be encapsulated in a shell that releases the material only within the temperature ranges described before.

Another type of crosslinker is a polyfunctional monomer compound that has at least two, preferably at least three, reactive vinyl or allyl groups per molecule. These materials are commonly known as “co-agents” because they are used mainly in combination with another type of crosslinker (mainly a peroxy compounds) to provide some early-stage branching. Examples of such co-agents include triallyl cyanurate, triallyl isocyanurate and triallylmellitate. Triallylsilane compounds are also useful. Another suitable class of co-agents are polynitroxyl compounds, particularly compounds having at least two 2,2,6,6-tetramethyl piperidinyloxy (TEMPO) groups or derivatives of such groups. Examples of such polynitroxyl compounds are bis(1-oxyl-2,2,6,6-tetramethylpiperadine-4-yl)sebacate, di-t-butyl N oxyl, dimethyl diphenylpyrrolidine-1-oxyl, 4-phosphonoxy TEMPO or a metal complex with TEMPO. Other suitable co-agents include α-methyl styrene, 1,1-diphenyl ethylene as well as those described in U.S. Pat. No. 5,346,961. The co-agent preferably has a molecular weight below 1000.

The co-agent generally requires the presence of free radicals to engage in crosslinking reactions with the ethylene polymer or copolymer. For that reason, a free radical generating agent is generally used with a co-agent. The peroxy crosslinkers described before are all free radical generators, and if such crosslinkers are present, it is not usually necessary to provide an additional free radical initiator in the composition. Co-agents of this type are typically used in conjunction with such a peroxy crosslinker, as the co-agent can boost crosslinking. A co-agent is suitably used in very small quantities, such as from about 0.05 to 1% by weight of the composition, when a peroxy crosslinker is used. If no peroxy crosslinker is used, a co-agent is used in somewhat higher quantities.

Another type of suitable crosslinker is an epoxy- or anhydride-functional polyamide.

The expanding agent similarly is activated at the elevated temperatures described before, and, similar to before, the expanding agent can be activated at such elevated temperatures via a variety of mechanisms. Suitable types of expanding agents include compounds that react or decompose at the elevated temperature to form a gas; gasses or volatile liquids that are encapsulated in a material that melts, degrades, ruptures or expands at the elevated temperatures, expandable microspheres, substances with boiling temperatures ranging from 120° C. to 300° C., and the like. The expanding agent is preferably a solid material at 22° C., and preferably is a solid material at temperatures below 50° C.

Expanding agents can also be classified as exothermic (releasing heat as they generate a gas) and endothermic (absorbing heat as they release a gas). Exothermic types are preferred.

A preferred type of expanding agent is one that decomposes at elevated temperatures to release nitrogen or, less desirably, ammonia gas. Among these are so-called “azo” expanding agents (which are exothermic types), as well as certain hydrazide, semi-carbazides and nitroso compounds (many of which are exothermic types). Examples of these include azobisisobutyronitrile, azodicarbonamide, p-toluenesulfonyl hydrazide, oxybissulfohydrazide, 5-phenyl tetrazol, benzoylsulfohydroazide, p-toluolsulfonylsemicarbazide, 4,4′-oxybis(benzensulfonyl hydrazide) and the like. These expanding agents are available commercially under trade names such as Celogen® and Tracel®. Commercially available expanding agents that are useful herein include Celogen® 754A, 765A, 780, AZ, AZ-130, AZ1901, AZ760A, AZ5100, AZ9370, AZRV, all of which are azodicarbonamide types. Celogen®OT and TSH-C are useful sulfonylhydrazide types. Azodicarbonamide expanding agents are especially preferred.

Blends of two or more of the foregoing blowing agents may be used. Blends of exothermic and endothermic types are of particular interest.

Nitrogen- or ammonia releasing expanding agents as just described, the azo-types in particular, may be used in conjunction with an accelerator compound. The accelerator compound is especially preferred when the composition of the invention is to be expanded at temperatures below about 175° C., and especially below 160° C. Typical accelerator compounds include zinc benzosulphonate, and various transition metal compounds such as transition metal oxides and carboxylates. Zinc, tin and titanium compounds are preferred, such as zinc oxide; zinc carboxylates, particularly zinc salts of fatty acids such as zinc stearate; titanium dioxide; and the like. Zinc oxide and mixtures of zinc oxide and zinc fatty acid salts are preferred types. A useful zinc oxide/zinc stearate blend is commercially available as Zinstabe 2426 from Hoarsehead Corp, Monaca, Pa.

The accelerator compound tends to reduce the peak decomposition temperature of the expanding agent to a predetermined range. Thus, for example, azodicarbonamide by itself tends to decompose at over 200° C., but in the presence of the accelerator compound its decomposition temperature can be reduced to 140-150° C. or even lower. When used, the accelerator compound may constitute from 4 to 20% of the weight of the composition. Preferred amounts, when the composition is to be expanded at a temperature of below 175° C. and preferably below 160° C., are from 6 to 18% and a more preferred amount is from 10 to 18%. The accelerator may be added to the composition separately from the expanding agent. However, some commercial grades of expanding agent are sold as “preactivated” materials, and already contain some quantity of the accelerator compound. Those “preactivated” materials are also useful.

Another suitable type of expanding agent decomposes at elevated temperatures to release carbon dioxide. Among this type are sodium hydrogen carbonate, sodium carbonate, ammonium hydrogen carbonate and ammonium carbonate, as well as mixtures of one or more of these with citric acid. These are usually endothermic types which are less preferred unless used in conjunction with an exothermic type.

Still another suitable type of expanding agent is encapsulated within a polymeric shell. These are endothermic types of expanding agents and preferably are used in conjunction with an exothermic type. The shell melts, decomposes, ruptures or simply expands at temperatures within the aforementioned ranges. The shell material may be fabricated from polyolefins such as polyethylene or polypropylene, vinyl resins, ethylene vinyl acetate, nylon, acrylic and acrylate polymers and copolymers, and the like. The expanding agent may be a liquid or gaseous (at STP) type, including for example, hydrocarbons such as n-butane, n-pentane, isobutane or isopentane; a fluorocarbon such as R-134A and R152A; or a chemical expanding agent which releases nitrogen or carbon dioxide, as are described before. Encapsulated expanding agents of these types are commercially available as Expancel® 091WUF, 091WU, 009DU, 091DU, 092DU, 093DU and 950DU.

Compounds that boil at a temperature of from 120 to 300° C. may also be used as the expanding agent, but because they are endothermic types are less preferred unless used in conjunction with an exothermic type. These compounds include C₈₋₁₂ alkanes as well as other hydrocarbons, hydrofluorocarbons and fluorocarbons that boil within this temperature range.

The composition further contains at least one adhesion-promoting resin. The adhesion-promoting resin constitutes from about 5 to 30 weight percent of the composition. The adhesion-promoting resin should be compatible with the ethylene polymer (component (a)) at the relative proportions thereof present in the composition. Compatibility in this sense means only that the adhesion-promoting resin and the ethylene polymer (component (a)) can be melt-blended to form a mixture that is grossly uniform in composition. The adhesion-promoting resin should also have a melting temperature of no greater than 160° C., more preferably no greater than 150° C. and especially from 70 to 130° C. The adhesion-promoting resin may be a liquid at room temperature, provided that that the composition as a whole is solid at room temperature. However, it is preferred that the adhesion-promoting resin has a melting temperature of at least 50° C. Materials that are useful as the adhesion promoting resin include, for example:

e-1) thermoplastic copolymers of ethylene with one or more oxygen-containing comonomers (which are not silanes);

e-2) thermoplastic, elastomeric ethylene copolymers having a density of less than 0.900 g/cc;

e-3) thermoplastic polyester resins;

e-4) thermoplastic polyamide resins;

e-5) elastomeric polymers and copolymers of butadiene or isoprene; and

e-6) polyepoxide compounds (other than those falling within type e-1 above), which can be used in conjunction with epoxy curing agents.

The e-1) materials are copolymers of ethylene with one or more oxygen-containing comonomers (which are not silanes), which are ethylenically polymerizable and capable of forming a copolymer with ethylene. Examples of such comonomers include acrylic and methacrylic acids, alkyl and hydroxyalkyl esters of acrylic or methacrylic acid (such as methyl acrylate, ethyl acrylate and butyl acrylate), vinyl acetate, glycidyl acrylate or methacrylate, vinyl alcohol, and the like. Specific examples of such copolymers include ethylene-vinyl acetate copolymers, acid- or anhydride-modified ethylene-vinyl acetate copolymers, ethylene-alkyl (meth)acrylate copolymers such as ethylene-methyl acrylate copolymers, ethylene-ethyl acrylate copolymers or ethylene butyl acrylate copolymers; ethylene-glycidyl (meth)acrylate copolymers, ethylene-glycidyl (meth)acrylate-alkyl acrylate terpolymers, ethylene-vinyl alcohol copolymers, ethylene hydroxyalkyl(meth)acrylate copolymers, ethylene-acrylic acid copolymers, acid- and/or anhydride modified polyethylenes, acid- and/or anhydride-modified poly(methyl methacrylate), and the like.

Some commercially available materials of these types are sold under the trade names Elvaloy™ (Du Pont), Bynel™ (Du Pont) and Lotader™ (Arkema). Adhesion-promoting resins of particular interest include ethylene/methyl acrylate, ethylene/ethyl acrylate and ethylene/butyl acrylate copolymers, such as are sold by Du Pont under the trade name Elvaloy™. Resins of this type tend to promote adhesion to a substrate, such as an E-coated substrate. Other adhesion-promoting resins of particular interest include ethylene/acrylic ester/maleic anhydride and ethylene/alkyl acrylate/glycidyl methacrylate terpolymers, such as are sold by Arkema under the trade name Lotader™. Resins of this type also tend to promote adhesion to an E-coated substrate, and to oily galvanized steel, even after exposure to 38° C./100% relative humidity conditions for 7 days.

Still other adhesion-promoting resins of particular interest are acid-modified ethylene/vinyl acetate resins, anhydride-modified ethylene/vinyl acetate resins, acid- and anhydride-modified ethylene/vinyl acetate resins, acid-modified ethylene/acrylate copolymers, anhydride-modified ethylene acrylate copolymers, and anhydride-modified HDPE, LLDPE, LDPE and polypropylene resins, such as are sold by DuPont under the trade name Bynel™. Resins of this type tend to promote adhesion to oily cold rolled steel and oily galvanized steel, even after exposure to 38° C./100% relative humidity conditions for 7 days.

Suitable thermoplastic, elastomeric ethylene copolymers having a density of less than 0.905 g/cc include those sold by The Dow Chemical Company under the trade name Affinity™. Resins of this type tend to improve adhesion to e-coated steel.

Suitable thermoplastic polyesters that can be used as an adhesion-promoting resin include hot met adhesives of the type sold by Bostik under the trade designation Vitel™.

Suitable thermoplastic polyamides include those sold by under the trade designation Unirez™ by Arizona Chemicals and under the trade designation MacroMelt™ by Loctite Corporation. The polyamide may contain terminal functional groups such as amine groups, carboxyl groups and other types of functional groups. Polyamide type adhesion promoting resins have been found to greatly improve adhesion to oily cold rolled steel and oily galvanized steel, even after exposure to 38° C./100% relative humidity conditions for 7 days. Specific thermoplastic polyamides that are useful include Unirez™ 2614, Unirez™ 2651, Unirez™ 2656 and Unirez™ 2672 of which the first two are preferred.

Suitable elastomeric polymers and copolymers of butadiene or isoprene include polybutadiene, polyisoprene, and block copolymers of styrene and butadiene. These materials tend to improve adhesion to e-coated substrates.

Epoxide compounds that are useful as adhesion promoting resins include a wide range of epoxy resins, such as diglycidyl ethers of polyhydric phenols, diglycidyl ethers of polyglycols, epoxy novolac resins and cycloaliphatic epoxides. Other suitable epoxide compounds are epoxy-containing polymers such as are present in coating compositions that are used in cationic deposition (E-coat) processes.

Mixtures of two or more of the foregoing adhesion-promoting resins are of interest, particularly when adhesion to a number of different substrates is desired. Mixture of adhesion-promoting resins of particular interest include:

1. A mixture of at least one ethylene/methyl acrylate, ethylene/ethyl acrylate or ethylene/butyl acrylate copolymer with at least one ethylene/acrylic ester/maleic anhydride or ethylene/alkyl acrylate/glycidyl methacrylate terpolymer. These mixtures tend to provide good adhesion to E-coated substrates. A composition containing such a mixture of adhesion-promoting resins preferably contains from 2 to 10 weight percent of the ethylene/methyl acrylate, ethylene/ethyl acrylate or ethylene/butyl acrylate copolymer(s) and from 3 to 15 weight percent of the one ethylene/acrylic ester/maleic anhydride or ethylene/alkyl acrylate/glycidyl methacrylate terpolymer(s).

2. A mixture of at least one ethylene/methyl acrylate, ethylene/ethyl acrylate or ethylene/butyl acrylate copolymer with at least one polyamide resin. A composition containing such a mixture preferably contains from 2 to 10 weight percent of the ethylene/methyl acrylate, ethylene/ethyl acrylate or ethylene/butyl acrylate copolymer(s) and from 3 to 15 weight percent of the polyamide resin(s).

3. A mixture of at least one ethylene/acrylic ester/maleic anhydride or ethylene/alkyl acrylate/glycidyl methacrylate terpolymer with at least one polyamide resin. A composition containing such a mixture preferably contains from 3 to 15 weight percent of the terpolymer(s) and from 3 to 15 weight percent of the polyamide resin(s).

4. A mixture of at least one ethylene/methyl acrylate, ethylene/ethyl acrylate or ethylene/butyl acrylate copolymer with at least one ethylene/acrylic ester/maleic anhydride or ethylene/alkyl acrylate/glycidyl methacrylate terpolymer and at least one polyamide resin. A composition containing such a mixture preferably contains from 2 to 10 weight percent of the copolymer, from 3 to 15 weight percent of the terpolymer(s), from 3 to 15 weight percent of the polyamide resin(s).

Mixtures 2, 3 and 4 tend to provide good adhesion to e-coated substrates, cold rolled steel and galvanized steel. Other useful mixtures of adhesion-promoting resins include:

5. A mixture of at least one ethylene/methyl acrylate, ethylene/ethyl acrylate or ethylene/butyl acrylate copolymer with at least one acid-modified and/or anhydride-modified ethylene/vinyl acetate copolymer, acid-modified and/or anhydride-modified ethylene/acrylate copolymer or acid-modified and/or anhydride-modified HDPE, LLDPE, LDPE or polypropylene resins. A composition containing such a mixture preferably contains from 2 to 10 weight percent of the ethylene/methyl acrylate, ethylene/ethyl acrylate or ethylene/butyl acrylate copolymer, and from 3 to 15 weight percent of the acid- and/or anhydride-modified material.

6. Any of mixtures 1-4, which further contains a polyester resin. Compositions containing such mixtures preferably contain from 2 to 12 weight percent of the polyester resin.

7. A mixture of at least one polyamide resin with a polyester resin. A composition containing such a mixture preferably contains from 3 to 15 weight percent of the polyamide and from 3 to 15 weight percent of the polyester.

The composition of the invention may also contain one or more antioxidants. Antioxidants can help prevent charring or discoloration that can be caused by the temperatures used to expand and crosslink the composition. This has been found to be particularly important when the expansion temperature is about 170° C. or greater, especially 190° C. to 220° C. The presence of antioxidants, at least in certain quantities, does not significantly interfere with the crosslinking reactions. This is surprising, particularly in the preferred cases in which a peroxy expanding agent is used, as these are strong oxidants, the activity of which would be expected to be suppressed in the presence of antioxidants.

Suitable antioxidants include phenolic types, organic phosphites, phosphines and phosphonites, hindered amines, organic amines, organo sulfur compounds, lactones and hydroxylamine compounds. Examples of suitable phenolic types include tetrakis methylene (3,5-di-t-butyl-4-hydroxyhydrocinnamate) methane, octadecyl 3,5-di-t-butyl-4-hydroxyhydrocinnamate, 1,3,5-tris(3,5-di-t-butyl-4-hydroxybenzyl)-s-triazine-2,4,6-(1H, 3H, 5H) trione, 1,1,3-tris(2′methyl-4′hydroxy-5′t-butylphenyl)butane, octadecyl-3-(3′,5′-di-t-butyl-4′-hydroxyphenyl)propionate, 3,5-bis(1,1-dimethylethyl)-4-hydroxybenzene propionic acid C13-15 alkyl esters, N,N-hexamethylene bis(3,5-di-t-butyl-4-hydroxyphenyl)propionamide, 2,6-di-t-butyl-4-methylphenol, bis[3,3-bis-(4′hydroxy-3′t-butylphenyl)butanoic acid] glycol ester (Hostanox O3 from Clariant) and the like. Tetrakis methylene (3,5-di-t-butyl-4-hydroxyhydrocinnamate) methane is a preferred phenolic antioxidant. Phenolic type antioxidants are preferably used in amount from 0.2 to 0.5% by weight of the composition.

Suitable phosphite stabilizers include bis(2,4-dicumylphenyl) pentaerythritol diphosphite, tris(2,4-di-tert-butylphenyl) phosphite, distearyl pentaerythritol diphosphite, bis-(2,4-di-t-butylphenyl)-pentaerythritol diphosphite and bis-(2,4-di-t-butyl-phenyl)-pentaerythritol-diphosphite. Liquid phosphite stabilizers include trisnonylphenol phosphite, triphenyl phosphite, diphenyl phosphite, phenyl diisodecyl phosphite, diphenyl isodecyl phosphite, diphenyl isooctyl phosphite, tetraphenyl dipropyleneglycol diphosphite, poly(dipropyleneglycol) phenyl phosphite, alkyl (C10-C15) bisphenol A phosphite, triisodecyl phosphite, tris(tridecyl) phosphite, trilauryl phosphite, tris(dipropylene glycol) phosphite and dioleyl hydrogen phosphite.

A preferred quantity of the phosphite stabilizer is from 0.1 to 1% of the weight of the composition.

A suitable organophosphine stabilizer is 1,3 bis-(diphenylphospino)-2,2-dimethylpropane. A suitable organophosphonite is tetrakis(2,4-di-t-butylphenyl-4,4′-biphenylene diphosphonite (Santostab P-EPQ from Clariant).

A suitable organosulfur compound is thiodiethylene bis[3-(3,5-di-t-butyl-4-hydroxyphenyl)proprionate].

Preferred amine antioxidants include octylated diphenylamine, the polymer of 2,2,4,4-tetramethyl-7-oxa-3,20-diaza-dispiro[5.1.11.2]-heneicosan-21-on (CAS No 64338-16-5, Hostavin N30 from Clariant), 1,6-hexaneamine, N,N′-bis(2,2,6,6-tetramethyl-4-piperidinyl)-, polymers with morpholine-2,4,6-trichloro-1,3,5-triazine reaction products, methylated (CAS number 193098-40-7, commercial name Cyasorb 3529 from Cytec Industries), poly-[[6-(1,1,3,3-tetramethylbutyl)amino]-s-triazine-2,4-diyl][2,2,6,6-tetramethyl-4-piperidyl)imino]hexamethylene[(2,2,6,6-tetramethyl-4-piperidyl)imino]] (CAS No 070624-18-9 (Chimassorb 944 from Ciba Specialty Chemicals), 1,3,5-triazine-2,4,6-triamine-N,N′″-[1,2-ethanediylbis[[[4,6-bis[butyl-(1,2,2,6,6-pentamethyl-4piperidinyl)amino]-1,3,5-triazine-2yl]imino]-3,1-propanediyl]]-bis-[N′,N″-dibutyl-N′,N′-bis(1,2,2,6,6-pentamethyl-4-piperidinyl)-106990-43-6 (Chimassorb 119 from Ciba Specialty Chemicals), and the like. The most preferred amine is 1,3,5-triazine-2,4,6-triamine-N,N′″-[1,2-ethanediylbis[[[4,6-bis[butyl-(1,2,2,6,6-pentamethyl-4-piperidinyl)amino]-1,3,5-triazine-2yl]imino]-3,1-propanediyl]]-bis-[N′,N″-dibutyl-N′,N′-bis(1, 2, 2,6,6-pentamethyl-4-piperidinyl. The composition of the invention preferably contains from 0.2 to 0.4% by weight of an amine antioxidant.

A suitable hydroxylamine is hydroxyl bis(hydrogenated tallow alkyl)amine, available as Fiberstab 042 from Ciba Specialty Chemicals.

A preferred antioxidant is a mixture of a hindered phenol and hindered amine and a more preferred antioxidant system is a mixture of hindered phenol, amine stabilizer, and a phosphite.

The composition may contain additional components to improve adhesion to various substrates during the expansion process. Examples of these include fillers that absorb oily materials. Bentonite clays are such a material, as are talc, calcium carbonate and wollastonite. In addition, various hydrolysable silanes or functional silane compounds can be used. These should be thermally stable at the temperature of the expansion step. Tris(3-(trimethyoxysilyl)isocyanurate) and β-(3,4-epoxycyclohexyl)ethyltriethoxysilane are examples of useful silane compounds.

In addition to the foregoing components, the composition may contain optional ingredients such as fillers, colorants, dies, preservatives, surfactants, cell openers, cell stabilizers, fungicides and the like. In particular, the composition may contain one or more polar derivatives of 2,2,6,6-tetramethyl piperidinyloxy (TEMPO) such as 4-hydroxy TEMPO, not only to retard scorch and/or boost crosslinking, but also to enhance adhesion to polar substrates.

The polyolefin composition is prepared by mixing the various components, taking care to maintain temperatures low enough that the expanding and crosslinking agents are not significantly activated. The mixing of the various components may be done all at once, or in various stages.

A preferred mixing method is a melt-processing method, in which the ethylene polymer (component (a)) is heated above its softening temperature and blended with one or more other components, usually under shear. A variety of melt-blending apparatus can be used, but an extruder is a particularly suitable device, as it allows for precise metering of components, good temperature control, and permits the blended composition to be formed into a variety of useful cross-sectional shapes. Temperatures during such a mixing step are desirably controlled low enough that any heat-activated materials as may be present (i.e, the expanding agent(s), crosslinkers, catalysts therefore and the like), do not become significantly activated. However, it is possible to exceed such temperatures if the residence time of the heat-activated materials at such temperatures is short. A small amount of activation of these materials can be tolerated. For example, a small amount of crosslinking agent activation can be tolerated, provided that the formation of gels during the mixing step is minimal. When the ethylene polymer (component (a)) is not long-chain branched, a certain amount of crosslinking during this step may be beneficial, as it may improve the melt rheology of the ethylene polymer, in particular, by increasing the melt strength. The gel content produced during the mixing step should be less than 10% by weight and is preferably less than 2% by weight of the composition. Greater gel formation causes the composition to become non-uniform, and to expand poorly during the expansion step. Similarly, some activation of the expanding agent can be tolerated, provided that enough unreacted expanding agent remains after the mixing step so that the composition can expand sufficiently during the expansion step. If expanding agent loss is expected during this process, extra quantities may be provided to compensate for this loss.

The crosslinking and/or blowing agents may also be added during the mixing step, or may be soaked into the polymer (preferably when the polymer is in the form of pellets, powder or other high surface area form) prior to melt-mixing and fabrication of part.

It is of course possible to use somewhat higher temperatures to melt blend those components which are not heat-activated. Accordingly, the composition can be formed by performing a first melt-blend step at a higher temperature, cooling somewhat, and then adding the heat-activated component(s) at the lower temperatures. It is possible to use an extruder with multiple heating zones to first melt-blend components that can tolerate a higher temperature, and then cool the mixture somewhat to blend in the heat-activated materials.

It is also possible to form one or more concentrates or masterbatches of various components in the component a) material and the adhesion-promoting resin(s), and let the concentrate or masterbatch down to the desired concentrations by melt blending with more of the component a) material or adhesion-promoting resin(s). Solid ingredients may be dry-blended together before the melt-blending step.

A useful method of producing the composition is an extrusion process using an apparatus which has multiple heating zones that can be heated (or cooled) independently to different temperatures. The apparatus also has at least two ports for introducing raw materials, one being downstream of the other, so that heat-activated materials can be introduced separately from the polyolefin polymer. In this method, the polyolefin is introduced into the apparatus and melted in one or more of the heating zones. Melt temperatures in these heating zones can be significantly higher than the activation temperatures of the blowing and crosslinking agents, if desired. Additives which are not heat-activated, such as the blowing agent accelerator, optional copolymer and antioxidant, can be added at this stage, if desired, either simultaneously with or separately from the polyolefin resin. The resulting molten polymer is then transferred to subsequent heating zones, which are maintained within a temperature range of 100 to 150° C., preferably 115 to 135° C., and the heat-activated components (blowing agent and crosslinker) are fed in. Cooling is generally needed because the polyolefin is typically heated to higher temperatures in the upstream sections of the device in order to facilitate thorough melting, and because shear introduced by the mixing apparatus (typically the screw or screws of an extruder), introduces significant energy which tends to heat the composition. Cooling can be applied in many ways. A convenient cooling method is to supply a cooling fluid (such as water) to a jacket on the mixing apparatus. The addition of the heat-activated components also tends to have a certain amount of cooling effect. The mixing apparatus provides sufficient residence time downstream of the addition of the heat-activated materials that they are uniformly mixed into the composition, but this residence time is preferably minimized so that little activation of those materials occurs. The mixed composition is then brought to an extrusion temperature, which is preferably below 155° C. and more preferably from 120 to 150° C., and passed through a die.

A melt-blended composition of the invention is then cooled below the softening temperature of the component a) material to form a solid, non-tacky product. The composition can be formed into a shape that is suitable for the particular reinforcing or insulation application. This is most conveniently done at the end of the melt-blending operation. As before, an extrusion process is particularly suitable for shaping the composition, in cases where pieces of uniform cross-section are acceptable. In many cases, the cross-sectional shape of the pieces is not critical to its operation, provided that they are small enough to fit within the cavity to be reinforced or insulated. Therefore, for many specific applications, an extrudate of uniform cross-section can be formed and simply cut into shorter lengths as needed to provide the quantity of material needed for the particular application.

Alternatively, the melt-blended composition can be extruded and cut into pellets, or otherwise formed into small particles which can be poured or placed into a cavity and expanded. Particles may also be packaged into a mesh or film container for insertion into a cavity. In such a case, the package must allow the particles to expand and so must either stretch, melt, degrade or rupture during the expansion process. A thermoplastic packaging material may melt under the expansion conditions. In such a case, the melting packaging material may function as an adhesive layer which helps to improve the adhesion of the expanded composition to the surrounding cavity.

If necessary for a specific application, the composition may be molded into a specialized shape using any suitable melt-processing operation, including extrusion, injection molding, compression molding, cast molding, injection stretch molding, and the like. As before, temperatures are controlled during such process to prevent premature gelling and expansion.

Solution blending methods can be used to blend the various components of the composition. Solution blends offers the possibility of using low mixing temperatures, and in that way helps to prevent premature gellation or expansion. Solution blending methods are therefore of particular use when the crosslinker and/or expansion agent become activated at temperatures close to those needed to melt-process the ethylene polymer (component a)). A solution-blended composition may be formed into desired shapes using methods described before, or by various casting methods. It is usually desirable to remove the solvent before the composition is used in the expanding step, to reduce VOC emissions when the product is expanded, and to produce a non-tacky composition. This can be done using a variety of well-known solvent removal processes.

The composition of the invention preferably is capable of expanding to at least 1000%, more preferably at least 1500%, even more preferably at least 1800%, and still more preferably at least 2000%, of its initial volume when evaluated in accordance with the test described in Examples 2-5 below. The composition may expand by as much as 3500% of its initial volume on that test. An advantage of this invention is that expansions of 1800% or greater are often obtained, and the resulted expanded material remains dimensionally stable when subjected to multiple heating cycles as described below.

The composition of the invention preferably exhibits excellent adhesion to a variety of substrates when expanded in the presence of that substrate. When evaluated according to the test described in Examples 2-5 below, the expanded composition preferably exhibits at least 50%, more preferably at least 60% and even more preferably at least 80% cohesive failure, when the substrate is e-coated steel, oily cold rolled steel or galvanized steel. Especially preferred compositions of the invention provide similar results after aging for 7 days at 38° C. and 100% relative humidity.

The composition of the invention is expanded by heating to a temperature in the range of 120 to 300° C., preferably from 140 to 230° C. and especially from 140 to 210° C., in the presence of a substrate. The particular temperature used will in general be high enough to soften the ethylene polymer (component a)) and activate both the heat-activated expansion agent and heat-activated crosslinker. For this reason, the expansion temperature will generally be selected in conjunction with the choice of resins, expansion agent and crosslinker. It is also preferred to avoid temperatures that are significantly higher than required to expand the composition, in order to prevent thermal degradation of the resin or other components. Expansion and cross-linking typically occurs within 1 to 60 minutes, especially from 5 to 40 minutes and most preferably from 5 to 20 minutes.

The expansion step is performed under conditions such that the composition rises freely to at least 100%, preferably at least 1000% of its initial volume. It more preferably expands to at least 1800% of its initial volume, and even more preferably expands to at least 2000% of its initial volume. The composition of the invention may expand to 3500% or more of its initial volume. More typically, it expands to up 1800 to 3000% of its initial volume. Note that the amount of expansion in particular applications may be somewhat lower than is obtained in the test described in Examples 2-5. This can be due to various factors, including the particular geometry of the cavity in which the composition is to expand. The density of the expanded material is generally from 1 to 10 pounds/cubic foot (16-160 kg/m³) and preferably from 1.5 to 5 pounds/cubic foot (24-80 kg/m³).

In this invention, a composition is said to “expand freely”, if the composition is not maintained under superatmospheric pressure or other physical constraint in at least one direction as it is brought to a temperature sufficient to initiate crosslinking and activate the expanding agent. As a result, the composition can begin to expand in at least one direction as soon as the necessary temperature is achieved, and can expand to at least 100%, to at least 500% and to at least 1000%, to at least 1500%, to at least 1800% or to at least 2000% of its initial volume without constraint. Most preferably, the composition can fully expand without constraint. In the free expansion process, crosslinking therefore occurs simultaneously with expansion, as the composition is free to expand at the time that the crosslinking reaction is taking place. This free expansion process differs from processes such as extrusion foaming or bun foam processes, in which the heated composition is maintained under pressure sufficient to keep it from expanding until the resin has become crosslinked and the crosslinked resin passes through the die of the extruder or the pressure is released to initiate “explosive foaming”. The timing of the crosslinking and expansion steps is much more critical in a free expansion process than in a process like extrusion, in which expansion can be delayed through application of pressure until enough crosslinking has been produced in the polymer. The ability to produce highly-expanded foam from ethylene homopolymers or interpolymers of ethylene with another α-olefin or a non-conjugated diene or triene monomer in a free expansion process is surprising.

The expanded polyolefin composition may be mainly open-celled, mainly closed-celled, or have any combination of open and closed cells. For many applications, low water absorption is a desired attribute of the expanded composition. It preferably absorbs no more than 30% of its weight in water when immersed in water for 4 hours at 22° C., when tested according to General Motors Protocol GM9640P, Water Absorption Test for Adhesives and Sealants (January 1992).

The expanded polyolefin composition exhibits excellent ability to attenuate sound having frequencies in the normal human hearing range. A suitable method for evaluating sound attenuation properties of an expanded polymer is through an insertion loss test. The test provides a reverberation room and a semiechoic room, separated by a wall with a 3″×3″×10″(7.5×7.5×25 mm) channel connecting the rooms. A foam sample is cut to fill the channel and inserted into it. A white noise signal is introduced into the reverberation room. Microphones measure the sound pressure in the reverberation room and in the semiechoic room. The difference in sound pressure in the rooms is used to calculate insertion loss. Using this test method, the expanded composition typically provides an insertion loss of 20 dB throughout the entire frequency range of 100 to 10,000 Hz. This performance over a wide frequency range is quite unusual and compares very favorably with polyurethane and other types of foam baffle materials.

The expandable composition of the invention is useful in a wide variety of applications, such as wire and cable insulation, protective packaging, construction materials such as flooring systems, sound and vibration management systems, toys, sporting goods, appliances, a variety of automotive applications, appliances, lawn and garden products, personal protective wear, apparel, footwear, traffic cones, housewares, sheets, barrier membranes, tubing and hoses, profile extrusions, seals and gaskets, upholstery, luggage, tapes and the like.

Applications of particular interest are structural reinforcement, sealing and particularly insulation (sound, vibration and/or thermal) applications, especially in the ground transportation (especially automotive) industry. The composition of the invention is readily deposited into a cavity that needs structural reinforcement and/or insulating, and expanded in place to partially or entirely fill the cavity. “Cavity” in this context means only some space that is to be filled with a reinforcing or insulating material. No particular shape is implied or intended. However, the cavity should be such that the composition can expand freely in at least one direction as described before. Preferably, the cavity is open to the atmosphere such that pressure does not build up significantly in the cavity as the expansion proceeds.

Examples of vehicular structures that are conveniently reinforced, sealed and/or insulated using the invention include reinforcement tubes and channels, rocker panels, pillar cavities, rear tail lamp cavities, upper C-pillars, lower C-pillars, front load beams or other hollow parts. The structure may be composed of various materials, including metals (such as cold-rolled steel, galvanized surfaces, galvanel surfaces, galvalum, galfan and the like), ceramics, glass, thermoplastics, thermoset resins, painted surfaces and the like. Structures of particular interest are coated (such as with a cationic deposition coating) either prior to or after the composition of the invention is introduced into the cavity. In such cases, the expansion of the composition can be conducted simultaneously with the bake cure of the coating.

If desired, the expanded composition of the invention can also function as a block or dam which controls the spread or position of another, after-applied material, such as a bulk foam or adhesive. In such embodiments, the expanded composition can be used to create pre-determined sites at which a bulk foam, adhesive or other material can be applied. This is particularly useful in applying a structural foam for localized structural reinforcement or an acoustical foam for additional reduction of sound into the vehicle or a structural adhesive to specified locations, for bonding the reinforced part to another material.

Compositions used for these automotive applications advantageously are expandable within the entire temperature range of 150 to 210° C., so that multiple formulations are not required for different commonly-used bake temperatures. Especially preferred compositions achieve expansion under such conditions to at least 1800% of their initial volume within 10 to 40 minutes, especially within 10 to 30 minutes.

The rheological characteristics and reaction profile of the composition of the invention are generally such that the composition remains somewhat viscous during the heating and expansion process. An advantage of the invention is that softening/melting, expansion and crosslinking tend to be staged so that the composition does not go through a very low viscosity stage. This attribute is favored when the melt index of the ethylene polymer (component (a)) is lower. As a result, the composition tends not to run to the bottom of the cavity during the expansion step. The composition is readily adaptable to applications where only a portion of a cavity needs reinforcement or insulating. In such cases, the unexpanded composition is applied only to that portion of the cavity where needed, and subsequently expanded in place. If necessary, the unexpanded composition may be affixed in a specific location within the cavity through a variety of supports, fasteners and the like, which can be, for example, mechanical or magnetic. Examples of such fasteners include blades, pins, push-pins, clips, hooks and compression fit fasteners. Adhesives may be used to affix the composition into position prior to expansion. The unexpanded composition can easily be extruded or otherwise shaped such that it can be readily affixed to such a support or fastener. It may be cast molded over such a support or fastener. The unexpanded composition may instead be shaped in such a way that it is self-retaining within a specific location within the cavity. For example, the unexpanded composition may be extruded or shaped with protrusions or hooks that permit it to be affixed to a specific location within a cavity.

The following examples are provided to illustrate the invention, but is not intended to limit the scope thereof. All parts and percentages are by weight unless otherwise indicated.

### EXAMPLE 1

Expandable polyolefin composition Example 1 is prepared from the following components:

| | |
|---|---|
| LDPE¹ | 60.7 |
| Dicumyl peroxide² | 2.5 |
| Azodicarbonamide³ | 15 |
| Zinc oxide | 8 |
| Zinc oxide/zinc stearate mixture⁴ | 7 |
| Ethylene/butyl acrylate/glycidyl | 5 |
| methacrylate interpolymer⁵ | |
| Antioxidant mixture⁶ | 1.8 |

¹621i from Dow Chemical.
²Perkadox BC-40BP from Akzo Nobel.
³AZ130 from Crompton Industries.
⁴Zinstabe 2426 from Hoarsehead Corp., Monaca, PA.
⁵Elvaloy 4170, from DuPont.
⁶A mixture of a hindered phenol, phosphite and hindered amine antioxidants.

The LDPE (LDPE 621i, from Dow Chemical) and ethylene/butyl acrylate/glycidyl methacrylate interpolymer are heated in a Haake Blend 600 for 5 minutes 115° C., with stirring at 30 rpm. The azodicarbonamide, zinc oxide and zinc oxide/zinc stearate mixture are added and mixed in for 30 minutes with continued stirring at 30 rpm. The dicumyl peroxide and antioxidant mixture are then added and mixed in as before. The mixture is then removed and allowed to cool to room temperature. After cooling, a solid composition is obtained. Samples of the composition are compression molded in window frame molds at 110° C. for 10 minutes with no measurable applied pressure. The thickness of the moldings is 0.5 inches (12.5 mm).

Samples of the molded composition are cut into equilateral triangles having sides 4 inches (10 mm) in length. Two of the triangles are inserted into the bottom of each of two duplicate triangularly-shaped metal columns. The walls of the columns are coated with an automotive cationic deposition (E-coat) composition. The triangular cross-section of the columns closely matches the dimensions of the cut piece of expandable polyolefin composition, such that all expansion of the composition will be upward. The first column is heated to 155° C. for 30 minutes (low bake conditions) to expand the composition. The expanded foam is then cooled to room temperature. The amount of expansion is determined by measuring the height of the expanded composition and comparing the height to the thickness of the unexpanded triangle. The composition expands to ˜2800% of its initial volume. The second column is heated to 205° C. for 40 minutes (high bake conditions), and the composition expands to ˜3100% of its initial volume. These results indicate that these compositions are suitable for use over a wide range of curing temperatures. This is significant in the automotive industry, where various E-coat bake temperatures are used. The ability of these compositions to expand over a range of temperatures permits eliminates the need to specially formulate the compositions for different electrocoat bake temperatures.

The mode of adhesive failure is evaluated on both of the expanded columns, by deconstructing the column and pulling the walls away from the expanded composition. The failure mode is examined for cohesive vs. adhesive failure, with 60% or more cohesive failure being the desired failure mode. In each case, nearly 100% cohesive failure is seen. Cohesive failure is the desired failure mode.

Two of the triangles are placed into duplicate oily cold rolled steel columns, and expanded under the low bake conditions. The columns containing the expanded material are cooled to room temperature. The mode of adhesive failure on one of the columns is evaluated immediately after cooling, as described before. This composition exhibits 5% cohesive failure. The other column is maintained at 38° C. and 100 relative humidity for 7 days, and the mode of adhesive failure is again evaluated. About 5% cohesive failure is seen.

Two more of the triangles are placed in to duplicate oily galvanized steel columns, expanded under the low bake conditions, and evaluated for failure mode as just described. Essentially 5% cohesive failure is seen.

Composition Example 1, when expanded, exhibits excellent adhesion to an E-coated substrate but less adhesion to oily substrates.

### EXAMPLES 2-5

Expandable composition Examples 2-5 are separately prepared in the same manner as described in Example 1. All compositions contain 15 weight percent azodicarbonamide, 3.0 weight percent dicumyl peroxide, 8 parts of zinc oxide, 7 parts of a zinc oxide/zinc stearate mixture and 1.8 parts of an antioxidant mixture, all as described in Example 1. The amount of LDPE used, and the type and amount of adhesion-promoting resins used, are described in Table 1. Adhesion-promoting resin A is the ethylene/butyl acrylate/glycidyl methacrylate interpolymer (Elvaloy 4170) described in Example 1. Adhesion promoting resin B is a polyamide hot melt adhesive that is available from Arizona Chemicals as Unirez™ 2614. Adhesion promoting resin C is another polyamide hot melt adhesive, Unirez™ 2651 from Arizona Chemicals. Adhesion promoting resin D is a maleic anhydride-modified ethylene/acrylate ester polymer which is sold as Bynel™ E418 by DuPont. Adhesion promoting resin E is a polyester hot melt adhesive sold as Vitel™ 1901 by Bostik.

1 cm cubes of each of Examples 2-5 are placed on top of duplicate E-coated metal plates, and expanded under the low bake and high bake conditions described in Example 1. % expansion is determined in each case as the average of three samples. Volume of the expanded samples is determined by immersion in water. Additional cubes are placed on top of duplicate oily cold rolled steel (CRS) columns and duplicate oil galvanized steel (GAL) plates and expanded under the low bake conditions described in Example 1. As before one of each of these expanded assemblies is conditioned for 7 days at 38° C. and 100% relative humidity. Adhesive failure is evaluated as described in Example 1. Results are as reported in Table 1.

TABLE 1

| | Example No. | | | |
|---|---|---|---|---|
| | 2 | 3 | 4 | 5 |
| Component | | | | |
| LDPE, % | 43.2 | 38.2 | 49.7 | 45.2 |
| Adhesion-promoting | 5.0 | 5.0 | 5.0 | 0.0 |
| resin A, % | | | | |
| Adhesion-promoting | 10.0 | 0 | 0 | 0 |
| resin B, % | | | | |
| Adhesion-promoting | 0 | 10.0 | 0 | 0 |
| resin C, % | | | | |
| Adhesion-promoting | 0 | 0 | 15.0 | 10.0 |
| resin D, % | | | | |
| Adhesion-promoting | 0 | 0 | 0 | 10.0 |
| resin E, % | | | | |
| Properties | | | | |
| Expansion, Low Bake/ | 2090/2324 | 2356/2176 | 2253/1952 | 2637/2358 |
| High Bake, % | | | | |
| Initial Adhesion, | 80/75 | 90/80 | 80/60 | 40/40 |
| % Cohesive | | | | |
| Failure, CRS/GAL | | | | |
| 7 Day, 38° C./100% | 70/90 | 80/75 | 60/90 | 50/50 |
| RH % Cohesive Failure, | | | | |
| CRS/GAL | | | | |

CRS is cold rolled steel.
GAL is galvanized steel.

The data in Table 1 shows that expandable compositions having very high expansions and very good adhesion even to oily substrates are provided by the invention. In Examples 2 and 3, the addition of the polyamide resin results in a very significant improvement in adhesion to CRS and galvanized steel (relative to Example 1), while retaining high expansion. Example 4 shows similar results using an anhydride-modified ethylene/acrylate ester polymer. In Example 5, nearly as good adhesion is obtained as in Example 4, with a greater expansion.

### EXAMPLES 6-9

Expandable composition Examples 6-9 are separately prepared and formed into triangles in the same manner as described in Example 1. All compositions contain 15 weight percent azodicarbonamide, 3.0 weight percent dicumyl peroxide, 8 parts of zinc oxide, 7 parts of a zinc oxide/zinc stearate mixture and 1.8 parts of an antioxidant mixture, all as described in Example 1. The amount of LDPE used, and the type and amount of adhesion-promoting resins used, are described in Table 2. Examples 8 and 9 contain 1% and 4% bentonite, respectively, as an oil-absorber. Adhesion-promoting resin F is an ethylene-acrylate ester-glycidyl methacrylate terpolymer available from Arkema as Lotader™ AX 8950. Expandable composition Examples 6-9 are evaluated as described with respect to Examples 2-5, with results as indicated in Table 2.

TABLE 2

| | Example No. | | | |
|---|---|---|---|---|
| | 6 | 7 | 8¹ | 9² |
| Component | | | | |
| LDPE, % | 55.7 | 50.7 | 49.7 | 45.2 |
| Adhesion-promoting | 0.0 | 5.0 | 5.0 | 5.0 |
| resin A, % | | | | |
| Adhesion-promoting | 10.0 | 10.0 | 10.0 | 10.0 |
| resin F, % | | | | |
| Properties | | | | |
| Expansion, Low Bake/ | 2500/2300 | 2900/2800 | 2899/2636 | 2637/2358 |
| High Bake, % | | | | |
| Initial Adhesion, | 90/90 | 90/95 | 80/80 | 70/75 |
| % Cohesive Failure, | | | | |
| CRS/GAL | | | | |
| 7 Day, 38° C./100% | 20/85 | 5/85 | 30/80 | 50/80 |
| RH % Cohesive Failure, | | | | |
| CRS/GAL | | | | |

¹Contains 1% bentonite.
²Contains 4% bentonite.

Expandable composition Examples 6 and 7 show excellent expansion and excellent initial adhesion to the cold rolled steel and galvanized steel. Both of these exhibit poorer adhesion to cold rolled steel after conditioning. In Examples 8 and 9, the addition of the bentonite improves the adhesion to cold rolled steel after conditioning.

### EXAMPLES 10-17

Expandable composition Examples 10-17 are separately prepared and formed into triangles in the same manner as described in Example 1. All compositions contain 15 weight percent azodicarbonamide, 3.0 weight percent dicumyl peroxide, 8 parts of zinc oxide, 7 parts of a zinc oxide/zinc stearate mixture and 1.8 parts of an antioxidant mixture, all as described in Example 1. The amount of LDPE used, and the type and amount of adhesion-promoting resins used, are described in Table 1. Examples 12 and 14 contain 1% each of tris(3-(trimethyoxysilyl)isocyanurate) and β-(3,4-epoxycyclohexyl)ethyltriethoxysilane. Adhesion promoting resin E is a polyester hot melt adhesive sold as Vitel™ 1901 by Bostik. Expandable composition Examples 10-17 are evaluated as described with respect to Examples 2-5, with results as indicated in Table 3.

TABLE 3

| | Example No. | | | | | | | |
|---|---|---|---|---|---|---|---|---|
| | 10 | 11 | 12¹ | 13 | 14¹ | 15 | 16 | 17 |
| Component | | | | | | | | |
| LDPE, % | 45.2 | 40.2 | 43.2 | 45.2 | 43.2 | 40.2 | 40.2 | 40.2 |
| Adhesion-promoting | 5.0 | 5.0 | 5.0 | 5.0 | 5.0 | 5.0 | 5.0 | 5.0 |
| resin A, % | | | | | | | | |
| Adhesion-promoting | 5.0 | 10.0 | 5.0 | 0 | 0 | 5.0 | 5.0 | 5.0 |
| resin B, % | | | | | | | | |
| Adhesion-promoting | 0 | 0 | 0 | 5.0 | 5.0 | 0 | 0 | 0 |
| resin C, % | | | | | | | | |
| Adhesion-promoting | 0 | 0 | 0 | 0 | 0 | 5.0 | 0 | 0 |
| resin D, % | | | | | | | | |
| Adhesion-promoting | 0 | 0 | 0 | 0 | 0 | 0 | 5.0 | 0 |
| resin E, % | | | | | | | | |
| Adhesion-promoting | 10.0 | 10.0 | 10.0 | 10.0 | 10.0 | 10.0 | 10.0 | 10.0 |
| resin F, % | | | | | | | | |
| Adhesion-promoting | 0 | 0 | 0 | 0 | 0 | 0 | 0 | 5.0 |
| resin G, % | | | | | | | | |
| Properties | | | | | | | | |
| Expansion, Low | 1795/ | 2735/ | 1378/ | 2125/ | 2132/ | 2594/ | 1306/ | 1210/ |
| Bake/ | 2127 | 1928 | 1856 | 2238 | 2356 | 2724 | 1621 | 1547 |
| High Bake, % | | | | | | | | |
| Initial Adhesion, % | 95% | 95% | 80/90 | 80/90 | 80/90 | 60/50 | 85/85 | 75/85 |
| Cohesive Failure, CRS/GAL | CRS | CRS | | | | | | |
| 7 Day, 38° C./100% RH | 80/80 | 50/90 | 70/85 | 80/90 | 75/90 | 60/50 | 85/85 | 85/85 |
| % Cohesive Failure, | | | | | | | | |
| CRS/GAL | | | | | | | | |

¹Contains 1% each of tris(3-(trimethyoxysilyl)isocyanurate) and β-(3,4-epoxycyclohexyl)ethyltriethoxysilane.

Among these, Examples 10, 13 and 14 show excellent expansion and adhesion to both the cold rolled steel and galvanized steel. Examples 12, 16 and 17 exhibit excellent adhesion but do not expand as much. Example 11 shows some reduced adhesion to cold rolled steel in the conditioned samples, and Example 15 shows some reduced adhesion to both substrates in the conditioned samples.

### EXAMPLES 18 AND 19

Expandable composition Examples 18 and 19 are separately prepared and formed into triangles in the same manner as described in Example 1. All compositions contain 15 weight percent azodicarbonamide, 3.0 weight percent dicumyl peroxide, 8 parts of zinc oxide, 7 parts of a zinc oxide/zinc stearate mixture and 1.8 parts of an antioxidant mixture, all as described in Example 1. The amount of LDPE used, and the type and amount of adhesion-promoting resins used, are described in Table 1. Adhesion-promoting resin H is an elastomeric ethylene-propylene copolymer sold as Affinity™ GA190 by The Dow Chemical Company. Adhesion-promoting resin I is an epoxidized hydroxyl-terminated polybutadiene sold as BD 605E by Sartomer Corporation. Expandable composition Example 19 contains 1% each of tris(3-(trimethyoxysilyl)isocyanurate) and β-(3,4-epoxycyclohexyl)ethyltriethoxysilane Examples 18 and 19 are evaluated as described with respect to Examples 2-5, with results as indicated in Table 4.

TABLE 4

Example No.

| | 18 | 19¹ |
|---|---|---|
| Component | | |
| LDPE, % | 40.2 | 38.2 |
| Adhesion-promoting resin A, % | 5.0 | 5.0 |
| Adhesion-promoting resin F, % | 10.0 | 10.0 |
| Adhesion-promoting resin H, % | 10.0 | 0 |
| Adhesion-promoting resin I, % | 0 | 10.0 |
| Properties | | |
| Expansion, Low Bake/ | 2837/2819 | 1182/1993 |
| High Bake, % | | |
| Initial Adhesion, % Cohesive | 65/65 | 90/80 |
| Failure, CRS/GAL | | |
| 7 Day, 38° C./100% RH % | 25/70 | 90/90 |
| Cohesive Failure, CRS/GAL | | |

¹Contains 1% each of tris(3-(trimethyoxysilyl)isocyanurate) and β-(3,4-epoxycyclohexyl)ethyltriethoxysilane.

Examples 18 exhibits excellent expansion and good adhesion under the initial adhesion test. Adhesion in the conditioned cold rolled steel test is somewhat lower. Example 19 shows somewhat lower expansion under the low bake conditions, but excellent adhesion to both the cold rolled steel and galvanized steel.

What is claimed is:

1. A solid, thermally expandable polyolefin composition, comprising:
a) from 35 to 65%, based on the weight of the composition, of (1) a crosslinkable ethylene homopolymer, (2) a crosslinkable interpolymer of ethylene and at least one C₃₋₂₀ α-olefin or non-conjugated diene or triene comonomer, (3) a crosslinkable ethylene homopolymer or interpolymer of ethylene and at least one C₃₋₂₀ α-olefin containing hydrolyzable silane groups or (4) a mixture of two or more of the foregoing, the homopolymer, interpolymer or mixture being non-elastomeric and having a melt index of from 0.5 to 30 g/10 minutes when measured according to ASTM D 1238 under conditions of 190° C./2.16 kg load;
b) from 0.5 to 8% by weight, based on the weight of the composition, of a heat activated crosslinker for component a), said crosslinker being activated when heated to a temperature of at least 120° C. but not more than 300° C.;
c) from 2 to 20%, based on the weight of the composition, of a heat-activated expanding agent that is activated when heated to a temperature of at least 120° C. but not more that 300° C.; and
d) from 2.5 to 30%, based on the weight of the composition, of an adhesion-promoting resin.

2. The composition of claim 1 wherein component a) is a crosslinkable ethylene homopolymer, a crosslinkable interpolymer of ethylene and at least one C₃₋₂₀ α-olefin or a mixture thereof.

3. The composition of claim 2 wherein the adhesion-promoting resin includes at least one thermoplastic copolymer of ethylene with one or more oxygen-containing comonomers, which comonomer is not a silane.

4. The composition of claim 2 wherein the adhesion-promoting resin includes at least one thermoplastic, elastomeric ethylene copolymer having a density of less than 0.900 g/cc.

5. The composition of claim 2 wherein the adhesion-promoting resin includes at least one thermoplastic polyester resin.

6. The composition of claim 2 wherein the adhesion-promoting resin includes at least one thermoplastic polyamide resin.

7. The composition of claim 2 wherein the adhesion-promoting resin includes at least one elastomeric polymer or copolymer of butadiene or isoprene.

9. The composition of claim 2 wherein the adhesion-promoting resin includes at least one polyepoxide compound.

9. The composition of claim 2 wherein the adhesion-promoting resin includes at least one ethylene/methyl acrylate, ethylene/ethyl acrylate or ethylene/butyl acrylate copolymer and at least one ethylene/acrylic ester/maleic anhydride or ethylene/alkyl acrylate/glycidyl methacrylate terpolymer.

10. The composition of claim 9 which contains from 2 to 10 weight percent of the ethylene/methyl acrylate, ethylene/ethyl acrylate or ethylene/butyl acrylate copolymer(s) and from 3 to 15 weight percent of the one ethylene/acrylic ester/maleic anhydride or ethylene/alkyl acrylate/glycidyl methacrylate terpolymer(s).

11. The composition of claim 2 wherein the adhesion-promoting resin includes least one ethylene/methyl acrylate, ethylene/ethyl acrylate or ethylene/butyl acrylate copolymer and at least one polyamide resin.

12. The composition of claim 11 wherein the adhesion-promoting resin contains from 2 to 10 weight percent of the ethylene/methyl acrylate, ethylene/ethyl acrylate or ethylene/butyl acrylate copolymer(s) and from 3 to 15 weight percent of the polyamide resin(s).

13. The composition of claim 2 wherein the adhesion-promoting resin includes at least one ethylene/acrylic ester/maleic anhydride or ethylene/alkyl acrylate/glycidyl methacrylate terpolymer and at least one polyamide resin.

14. The composition of claim 13 wherein the adhesion-promoting resin contains from 3 to 15 weight percent of the ethylene/acrylic ester/maleic anhydride or ethylene/alkyl acrylate/glycidyl methacrylate terpolymer(s) and from 3 to 15 weight percent of the polyamide resin(s).

15. The composition of claim 2 wherein the adhesion-promoting resin includes at least one ethylene/methyl acrylate, ethylene/ethyl acrylate or ethylene/butyl acrylate copolymer, at least one ethylene/acrylic ester/maleic anhydride or ethylene/alkyl acrylate/glycidyl methacrylate terpolymer and at least one polyamide resin.

16. The composition of claim 15 wherein the adhesion-promoting resin contains from 2 to 10 weight percent of the ethylene/methyl acrylate, ethylene/ethyl acrylate or ethylene/butyl acrylate copolymer, from 3 to 15 weight percent of the ethylene/acrylic ester/maleic anhydride or ethylene/alkyl acrylate/glycidyl methacrylate terpolymer terpolymer(s), from 3 to 15 weight percent of the polyamide resin(s).

17. The composition of claim 2 wherein the adhesion-promoting resin includes at least one ethylene/methyl acrylate, ethylene/ethyl acrylate or ethylene/butyl acrylate copolymer and at least one acid-modified and/or anhydride-modified ethylene/vinyl acetate copolymer, acid-modified and/or anhydride-modified ethylene/acrylate copolymer or acid-modified and/or anhydride-modified HDPE, LLDPE, LDPE or polypropylene resin.

18. The composition of claim 17 wherein the adhesion-promoting resin contains from 2 to 10 weight percent of the ethylene/methyl acrylate, ethylene/ethyl acrylate or ethylene/butyl acrylate copolymer, and from 3 to 15 weight percent of the acid-modified and/or anhydride-modified ethylene/vinyl acetate copolymer, acid-modified and/or anhydride-modified ethylene/acrylate copolymer or acid-modified and/or anhydride-modified HDPE, LLDPE, LDPE or polypropylene resin.

19. The composition of claim 1, wherein the expanding agent is an azo compound.

20. The composition of claim 19 wherein the composition further includes from 4 to 20% of zinc oxide or a mixture of zinc oxide and zinc stearate.

21. The composition of claim 20, wherein the crosslinking agent is an organic peroxide, peroxyester or peroxycarbonate.

22. A method comprising
1) inserting the solid, thermally expandable polyolefin composition of claim 1 into a cavity,
2) heating the thermally expandable polyolefin composition in the cavity to a temperature sufficient to expand and crosslink the polyolefin composition and
3) permitting the polyolefin composition to expand freely to form a foam that fills at least a portion of the cavity.

23. The method of claim 22 wherein the heat expansion step is performed by heating the polyolefin composition to a temperature from 140 to 220° C.

24. The method of claim 23 wherein in step 2) the composition expands to at least 1800% of its initial volume.

25. The method of claim 24 wherein at least a portion of the cavity is formed of an E-coated substrate, cold rolled steel or galvanized steel.

26. The method of claim 25 wherein the cavity is a tube, a reinforcement channel, a rocker panel, a pillar cavity or a front load beam.

27. The method of claim 24, wherein the part, assembly or sub-assembly is coated with a bake-curable coating, and the heat-expansion step is conducted as the bake-curable coating is cured.

28. The method of claim 27, wherein the part, assembly or sub-assembly includes a reinforcement tube, a reinforcement channel, a rocker panel, a pillar cavity or a front load beam.

29. A solid, thermally expandable polyolefin composition, comprising:
a) from 35 to 65%, based on the weight of the composition, of (1) a crosslinkable ethylene homopolymer, (2) a crosslinkable interpolymer of ethylene and at least one C₃₋₂₀ α-olefin or non-conjugated diene or triene comonomer, (3) a crosslinkable ethylene homopolymer or interpolymer of ethylene and at least one C₃₋₂₀ α-olefin containing hydrolyzable silane groups or (4) a mixture of two or more of the foregoing, the homopolymer, interpolymer or mixture being non-elastomeric and having a melt index of from 0.5 to 30 g/10 minutes when measured according to ASTM D 1238 under conditions of 190° C./2.16 kg load;
b) from 0.5 to 8% by weight, based on the weight of the composition, of a peroxide crosslinker for component a), said crosslinker being activated when heated to a temperature of at least 120° C. but not more than 300° C.;
c) from 10 to 20%, based on the weight of the composition, of an azo-type expanding agent that is activated when heated to a temperature of at least 120° C. but not more that 300° C.; and
d) from 5 to 30%, based on the weight of the composition, of an adhesion-promoting resin.

30. A method comprising
1) inserting the solid, thermally expandable polyolefin composition of claim 29 into a cavity,
2) heating the thermally expandable polyolefin composition in the cavity to a temperature sufficient to expand and crosslink the polyolefin composition and
3) permitting the polyolefin composition to expand freely to form a foam that fills at least a portion of the cavity.

31. A solid, thermally expandable polyolefin composition, comprising:
a) from 35 to 65%, based on the weight of the composition, of (1) a LDPE having a melt index of from 0.5 to 30 g/10 minutes when measured according to ASTM D 1238 under conditions of 190° C./2.16 kg load;
b) from 0.5 to 8% by weight, based on the weight of the composition, of a peroxide crosslinker for component a), said crosslinker being activated when heated to a temperature of at least 120° C. but not more than 300° C.;
c) from 10 to 20%, based on the weight of the composition, of an azo-type expanding agent that is activated when heated to a temperature of at least 120° C. but not more that 300° C.;
d) from 4 to 20%, based on the weight of the composition, of an accelerator for the azo-type expanding agent; and
e) from 5 to 30%, based on the weight of the composition, of an adhesion-promoting resin.

32. The composition of claim 31 wherein component a) is a crosslinkable ethylene homopolymer, a crosslinkable interpolymer of ethylene and at least one C₃₋₂₀ α-olefin or a mixture thereof.

33. The composition of claim 32 wherein the adhesion-promoting resin includes at least one thermoplastic copolymer of ethylene with one or more oxygen-containing comonomers, which comonomer is not a silane.

34. The composition of claim 32 wherein the adhesion-promoting resin includes at least one thermoplastic, elastomeric ethylene copolymer having a density of less than 0.900 g/cc.

35. The composition of claim 32 wherein the adhesion-promoting resin includes at least one thermoplastic polyester resin.

36. The composition of claim 32 wherein the adhesion-promoting resin includes at least one thermoplastic polyamide resin.

37. The composition of claim 32 wherein the adhesion-promoting resin includes at least one elastomeric polymer or copolymer of butadiene or isoprene.

38. The composition of claim 32 wherein the adhesion-promoting resin includes at least one polyepoxide compound.

39. The composition of claim 32 wherein the adhesion-promoting resin includes at least one ethylene/methyl acrylate, ethylene/ethyl acrylate or ethylene/butyl acrylate copolymer and at least one ethylene/acrylic ester/maleic anhydride or ethylene/alkyl acrylate/glycidyl methacrylate terpolymer.

40. The composition of claim 39 which contains from 2 to 10 weight percent of the ethylene/methyl acrylate, ethylene/ethyl acrylate or ethylene/butyl acrylate copolymer(s) and from 3 to 15 weight percent of the one ethylene/acrylic ester/maleic anhydride or ethylene/alkyl acrylate/glycidyl methacrylate terpolymer(s).

41. The composition of claim 32 wherein the adhesion-promoting resin includes least one ethylene/methyl acrylate, ethylene/ethyl acrylate or ethylene/butyl acrylate copolymer and at least one polyamide resin.

42. The composition of claim 41 wherein the adhesion-promoting resin contains from 2 to 10 weight percent of the ethylene/methyl acrylate, ethylene/ethyl acrylate or ethylene/butyl acrylate copolymer(s) and from 3 to 15 weight percent of the polyamide resin(s).

43. The composition of claim 32 wherein the adhesion-promoting resin includes at least one ethylene/acrylic ester/maleic anhydride or ethylene/alkyl acrylate/glycidyl methacrylate terpolymer and at least one polyamide resin.

44. The composition of claim 43 wherein the adhesion-promoting resin contains from 3 to 15 weight percent of the ethylene/acrylic ester/maleic anhydride or ethylene/alkyl acrylate/glycidyl methacrylate terpolymer(s) and from 3 to 15 weight percent of the polyamide resin(s).

45. The composition of claim 32 wherein the adhesion-promoting resin includes at least one ethylene/methyl acrylate, ethylene/ethyl acrylate or ethylene/butyl acrylate copolymer, at least one ethylene/acrylic ester/maleic anhydride or ethylene/alkyl acrylate/glycidyl methacrylate terpolymer and at least one polyamide resin.

46. The composition of claim 45 wherein the adhesion-promoting resin contains from 2 to 10 weight percent of the ethylene/methyl acrylate, ethylene/ethyl acrylate or ethylene/butyl acrylate copolymer, from 3 to 15 weight percent of the ethylene/acrylic ester/maleic anhydride or ethylene/alkyl acrylate/glycidyl methacrylate terpolymer terpolymer(s), from 3 to 15 weight percent of the polyamide resin(s).

47. The composition of claim 32 wherein the adhesion-promoting resin includes at least one ethylene/methyl acrylate, ethylene/ethyl acrylate or ethylene/butyl acrylate copolymer and at least one acid-modified and/or anhydride-modified ethylene/vinyl acetate copolymer, acid-modified and/or anhydride-modified ethylene/acrylate copolymer or acid-modified and/or anhydride-modified HDPE, LLDPE, LDPE or polypropylene resin.

48. The composition of claim 47 wherein the adhesion-promoting resin contains from 2 to 10 weight percent of the ethylene/methyl acrylate, ethylene/ethyl acrylate or ethylene/butyl acrylate copolymer, and from 3 to 15 weight percent of the acid-modified and/or anhydride-modified ethylene/vinyl acetate copolymer, acid-modified and/or anhydride-modified ethylene/acrylate copolymer or acid-modified and/or anhydride-modified HDPE, LLDPE, LDPE or polypropylene resin.

49. The composition of claim 32, wherein the adhesion-promoting resin further contains a polyester resin.

50. A method comprising
1) inserting the solid, thermally expandable polyolefin composition of claim 31 into a cavity,
2) heating the thermally expandable polyolefin composition in the cavity to a temperature sufficient to expand and crosslink the polyolefin composition and
3) permitting the polyolefin composition to expand freely to form a foam that fills at least a portion of the cavity.

51. The method of claim 50 wherein the heat expansion step is performed by heating the polyolefin composition to a temperature from 140 to 220° C.

52. The method of claim 51 wherein in step 2) the composition expands to at least 1800% of its initial volume.

53. The method of claim 52 wherein at least a portion of the cavity is formed of an E-coated substrate, cold rolled steel or galvanized steel.

54. The method of claim 53 wherein the cavity is a tube, a reinforcement channel, a rocker panel, a pillar cavity or a front load beam.

55. The method of claim 53, wherein the part, assembly or sub-assembly is coated with a bake-curable coating, and the heat-expansion step is conducted as the bake-curable coating is cured.

56. The method of claim 55, wherein the part, assembly or sub-assembly includes a reinforcement tube, a reinforcement channel, a rocker panel, a pillar cavity or a front load beam.
